(19) United States
(12) Patent Application Publication
(10) Pub. No.: US 2025/0062873 A1
(43) Pub. Date: Feb. 20, 2025

(54) METHOD AND APPARATUS FOR DETERMINING PILOT, AND READABLE STORAGE MEDIUM

(71) Applicant: Beijing Xiaomi Mobile Software Co., Ltd., Beijing (CN)

(72) Inventor: Ting FU, Beijing (CN)

(21) Appl. No.: 18/721,569

(22) PCT Filed: Dec. 24, 2021
(86) PCT No.: PCT/CN2021/141377

§ 371 Date: Jun. 18, 2024

(51) Int. Cl. H04L 5/00; H04W 24/08

(52) U.S. Cl. CPC H04L 5/0048; H04W 24/08

(57) ABSTRACT

A pilot determination method includes: receiving pilot configuration information for radio link monitoring or link recovery, sent by a network device, where the pilot configuration information at least includes semi-persistent pilot information; and determining a pilot for radio link monitoring or link recovery based on the pilot configuration information.

### CROSS-REFERENCE TO RELATED APPLICATIONS

The present application is a U.S. National Stage of International Application No. PCT/CN2021/141377, entitled “PILOT DETERMINATION METHOD AND APPARATUS AND READABLE STORAGE MEDIUM”, filed on Dec. 24, 2021, the contents of all of which are incorporated herein by reference in their entireties for all purposes.

### BACKGROUND

With the wide application of wireless communication technologies, such as the wide application of a 5th Generation Mobile Communication Technology (5G), the demands for energy saving in wireless communication systems are becoming more prominent.

How to improve an energy-saving effect in a direction of transmission pilot is a technical problem that needs to be solved.

### SUMMARY

The disclosure relates to the technical field of wireless communication, and more particularly, to a method and apparatus for determining pilot, and a readable storage medium.

In a first aspect, a method for determining pilot is provided. This method is performed by user equipment and includes:
receiving pilot configuration information for radio link monitoring or link recovery sent by a network device, where the pilot configuration information at least includes semi-persistent pilot information; and
determining a pilot for radio link monitoring or link recovery based on the pilot configuration information.

In a second aspect, a method for determining pilot is provided. This method is performed by a network device and includes:
sending pilot configuration information for radio link monitoring or link recovery to user equipment, where the pilot configuration information at least includes semi-persistent pilot information; where the pilot configuration information is configured for the user equipment to determine a pilot for radio link monitoring or link recovery.

In a third aspect, a method for determining pilot is provided. This method is performed by user equipment and includes:
receiving pilot configuration information for radio link monitoring or link recovery sent by a network device, where the pilot configuration information includes periodic pilot information; the periodic pilot information includes a first parameter set; and a first parameter in the first parameter set includes one or more of a period, an RB number, a frequency domain density, and a power parameter; and
determining a pilot for radio link monitoring or link recovery based on the periodic pilot information.

In a fourth aspect, a method for determining pilot is provided. This method is performed by a network device and includes:
sending pilot configuration information for radio link monitoring or link recovery to user equipment, where the pilot configuration information includes periodic pilot information; the periodic pilot information includes a first parameter set; a first parameter in the first parameter set includes one or more of a period, an RB number, a frequency domain density, and a power parameter; where the periodic pilot information is configured for the user equipment to determine a pilot for radio link monitoring or link recovery.

In a fifth aspect, a communication apparatus is provided. the communication apparatus may be configured to perform the steps performed by the user equipment in the first aspect. The user equipment may implement various functions in the above methods in the form of a hardware structure, a software module, or a combination of a hardware structure and a software module.

In a case that the communication apparatus shown in the first aspect is implemented through the software module, the communication apparatus may include a transceiving module and a processing module.

In response to performing the steps described in the first aspect, the transceiving module is configured to receive pilot configuration information for radio link monitoring or link recovery sent by a network device, where the pilot configuration information at least includes semi-persistent pilot information; and
the processing module is configured to determine a pilot for radio link monitoring or link recovery based on the pilot configuration information.

In a sixth aspect, a communication apparatus is provided. The communication apparatus may be configured to perform the steps performed by the network device in the second aspect. The network device may implement various functions in the above methods in the form of a hardware structure, a software module, or a combination of a hardware structure and a software module.

In a case that the communication apparatus shown in the second aspect is implemented through the software module, the communication apparatus may include a transceiving module.

In response to performing the steps described in the second aspect, the transceiving module is configured to send pilot configuration information for radio link monitoring or link recovery to user equipment, where the pilot configuration information at least includes semi-persistent pilot information; where the pilot configuration information is configured for the user equipment to determine a pilot for radio link monitoring or link recovery.

In a seventh aspect, a communication apparatus is provided. The communication apparatus may be configured to perform the steps performed by the user equipment in the third aspect. The user equipment may implement various functions in the above methods in the form of a hardware structure, a software module, or a combination of a hardware structure and a software module.

In a case that the communication apparatus shown in the third aspect is implemented through the software module, the communication apparatus may include a transceiving module and a processing module.

In response to performing the steps described in the third aspect, the transceiving module is configured to receive pilot configuration information for radio link monitoring or link recovery sent by a network device, where the pilot configuration information includes periodic pilot information; the periodic pilot information includes a first parameter set; and a first parameter in the first parameter set includes one or more of a period, an RB number, a frequency domain density, and a power parameter.

The processing module is configured to determine a pilot for radio link monitoring or link recovery based on the periodic pilot information.

In an eighth aspect, a communication apparatus is provided. The communication apparatus may be configured to perform the steps performed by the network device in the fourth aspect. The network device may implement various functions in the above methods in the form of a hardware structure, a software module, or a combination of a hardware structure and a software module.

In a case that the communication apparatus shown in the fourth aspect is implemented through the software module, the communication apparatus may include a transceiving module.

In response to performing the steps described in the fourth aspect, the transceiving module is configured to send pilot configuration information for radio link monitoring or link recovery to user equipment, where the pilot configuration information includes periodic pilot information; the periodic pilot information includes a first parameter set; a first parameter in the first parameter set includes one or more of a period, an RB number, a frequency domain density, and a power parameter; where the periodic pilot information is configured for the user equipment to determine a pilot for radio link monitoring or link recovery.

In a ninth aspect, a communication apparatus is provided. The communication apparatus includes a processor and a memory, where the memory is configured to store a computer program; and the processor is configured to execute the computer program to implement the first aspect.

In a tenth aspect, a communication apparatus is provided. The communication apparatus includes a processor and a memory, where the memory is configured to store a computer program; and the processor is configured to execute the computer program to implement the second aspect.

In an eleventh aspect, a communication apparatus is provided. The communication apparatus includes a processor and a memory, where the memory is configured to store a computer program; and the processor is configured to execute the computer program to implement the third aspect.

In a twelfth aspect, a communication apparatus is provided. The communication apparatus includes a processor and a memory, where the memory is configured to store a computer program; and the processor is configured to execute the computer program to implement the fourth aspect.

In a thirteenth aspect, a non-transitory computer-readable storage medium is provided. The non-transitory computer-readable storage medium is configured to store an instruction (or referred to as a computer program, or a program) which, when called and executed on a computer, causes the computer to perform the first aspect.

In a fourteenth aspect, a non-transitory computer-readable storage medium is provided. The non-transitory computer-readable storage medium is configured to store an instruction (or referred to as a computer program, or a program) which, when called and executed on a computer, causes the computer to perform the second aspect.

In a fifteenth aspect, a non-transitory computer-readable storage medium is provided. The non-transitory computer-readable storage medium is configured to store an instruction (or referred to as a computer program, or a program) which, when called and executed on a computer, causes the computer to perform the third aspect.

In a sixteenth aspect, a non-transitory computer-readable storage medium is provided. The non-transitory computer-readable storage medium is configured to store an instruction (or referred to as a computer program, or a program) which, when called and executed on a computer, causes the computer to perform the fourth aspect.

It is to be understood that the above general description and the following detailed description are illustrative and explanatory, and not intended to limit the disclosure.

### BRIEF DESCRIPTION OF DRAWINGS

The accompanying drawings illustrated here are used to provide a further understanding of the examples of the disclosure, and constitute a part of the disclosure. The illustrative examples and their explanations of the examples of the disclosure are used to explain the examples of the disclosure, and do not constitute an improper limitation on the examples of the disclosure. In the accompanying drawings:

The accompanying drawings here, which are incorporated in the specification and constitute a part of the specification, illustrate examples consistent with the examples of the disclosure, and together with the specification, serve to explain the principles of the examples of the disclosure.

FIG. 1 is a schematic diagram of an architecture of a wireless communication system provided by an example of the disclosure;

FIG. 2 is a flowchart of a method for determining pilot illustrated according to an illustrative example;

FIG. 3 is a flowchart of a method for determining pilot illustrated according to an illustrative example;

FIG. 4 is a flowchart of a method for determining pilot illustrated according to an illustrative example;

FIG. 5 is a flowchart of a method for determining pilot illustrated according to an illustrative example;

FIG. 6 is a flowchart of a method for determining pilot illustrated according to an illustrative example;

FIG. 7 is a flowchart of a method for determining pilot illustrated according to an illustrative example;

FIG. 8 is a flowchart of a method for determining pilot illustrated according to an illustrative example;

FIG. 9 is a flowchart of a method for determining pilot illustrated according to an illustrative example;

FIG. 10 is a structural diagram of an apparatus for determining pilot illustrated according to an illustrative example;

FIG. 11 is a structural diagram of an apparatus for determining pilot illustrated according to an illustrative example;

FIG. 12 is a structural diagram of an apparatus for determining pilot illustrated according to an illustrative example;

FIG. 13 is a structural diagram of an apparatus for determining pilot illustrated according to an illustrative example;

FIG. 14 is a structural diagram of an apparatus for determining pilot illustrated according to an illustrative example; and

FIG. 15 is a structural diagram of an apparatus for determining pilot illustrated according to an illustrative example.

### DETAILED DESCRIPTION

The examples of the disclosure are further illustrated now in conjunction with the accompanying drawings and specific examples.

The illustrative examples will be illustrated in detail here, and examples of which are shown in the accompanying drawings. When the following description refers to the accompanying drawings, unless otherwise indicated, the same numbers in different accompanying drawings indicate the same or similar elements. The examples described in the following illustrative examples do not represent all examples consistent with the examples of the disclosure. On the contrary, these examples are examples of apparatuses and methods consistent with some aspects of the disclosure, as detailed in the appended claims.

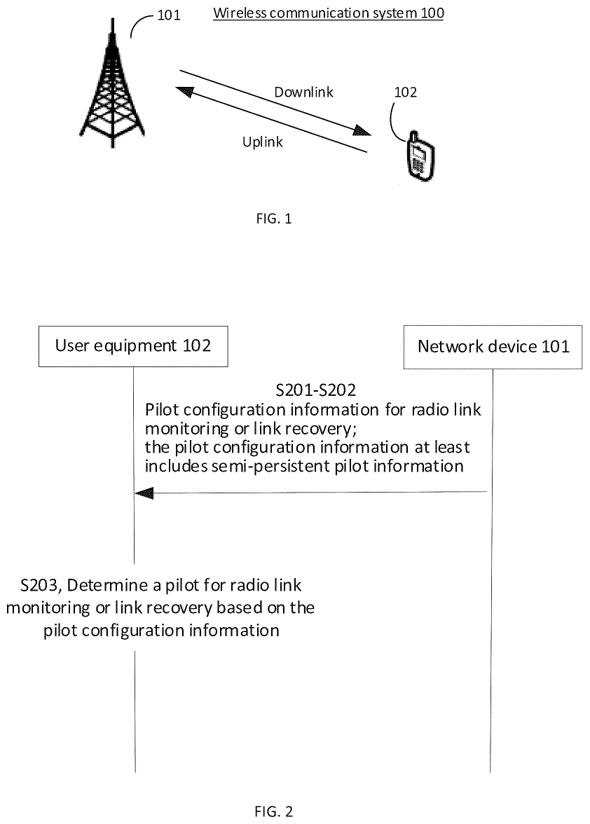

As shown in FIG. 1, a method for determining pilot provided by an example of the disclosure may be applied to a wireless communication system 100. The wireless communication system may include but be not limited to a network device 101 and user equipment 102. The user equipment 102 is configured to support carrier aggregation. The user equipment 102 may be connected to a plurality of carrier units of the network device 101, including a primary carrier unit and one or more secondary carrier units.

It is to be understood that the wireless communication system 100 may be applicable to both a low-frequency scenario and a high-frequency scenario. The application scenarios of the wireless communication system 100 include but are not limited to a long term evolution (LTE) system, an LTE frequency division duplex (FDD) system, an LTE time division duplex (TDD) system, a worldwide interoperability for microwave access (WiMAX) communication system, a cloud radio access network (CRAN) system, a future 5th-Generation (5G) system, a new radio (NR) communication system, or a future evolved public land mobile network (PLMN) system, etc.

The user equipment 102 shown above may be a user equipment (UE), a terminal, an access terminal, a terminal unit, a terminal station, a mobile station (MS), a remote station, a remote terminal, a mobile terminal, a wireless communication device, a terminal agent or user device, etc. The user equipment 102 may have a wireless transceiving function, capable of communicating (e.g., wireless communication) with one or more network devices 101 of one or more communication systems and accepting network services provided by the network device 101. The network device 101 here includes but is not limited to a base station as illustrated.

The user equipment 102 may be a cellular phone, a cordless phone, a session initiation protocol (SIP) phone, a wireless local loop (WLL) station, a personal digital assistant (PDA) device, a handheld device with a wireless communication function, a computing device, or other processing device connected to a wireless modem, a vehicle-mounted device, a wearable device, user equipment in a future 5G network, user equipment in a future evolved PLMN etc.

The network device 101 may be an access network device (or referred to as an access network site). Where, the access network device refers to a device that provides a network access function, such as a radio access network (RAN) base station. The network device may specifically include a base station (BS) device, or include a base station device and a wireless resource management device configured to control the base station device. The network device may further include a relay station (a relay device), an access point, as well as a base station in a future 5G network, a base station in a future evolved PLMN, or a NR base station. The network device may be a wearable device or vehicle-mounted device. The network device may also be a communication chip with a communication module.

For example, the network device 101 includes but is not limited to: a next-generation base station (gnodeB, gNB) in 5G, an evolved node B (eNB) in an LTE system, a radio network controller (RNC), a node B (NB) in a WCDMA system, a wireless controller under a CRAN system, a base station controller (BSC), a base transceiver station (BTS) in a GSM system or CDMA system, a home base station (e.g., home evolved nodeB, or home node B, HNB), a baseband unit (BBU), a transmitting and receiving point (TRP), a transmitting point (TP) or a mobile switching center, etc.

In an example, a pilot used for radio link monitoring and link recovery, for example, a channel state information reference signal (CSI-RS), can only use a periodic RS, rather than a semi-persistent or aperiodic RS.

In some application scenarios (e.g., in a low traffic scenario), a base station only serves a few UEs in a connected state, which may be UE located at an edge of a cell or UE located at the center of the cell. Channel conditions corresponding to the UE at the edge of the cell and the UE at the center of the cell are different, so the manners of sending a pilot for the two UEs are to be distinguished according to their channel conditions.

For example:

In the case that the UE at the edge of the cell has a poor channel condition, the pilot may be sent at a higher power, a smaller period, or a higher frequency domain density.

In the case that the UE at the center of the cell has a good channel condition, the pilot may be sent at a lower power, a larger period, or a lower frequency domain density.

The energy consumption of a network device may be saved by using a flexible and dynamic manner of sending a pilot.

An example of the disclosure provides a method for determining pilot. FIG. 2 is a flowchart of a method for determining pilot illustrated according to an illustrative example. As shown in FIG. 2, the method includes:

step S201, a network device 101 sends pilot configuration information for radio link monitoring or link recovery to user equipment 102, where the pilot configuration information at least includes semi-persistent pilot information;

step S202, the user equipment 102 receives the pilot configuration information for radio link monitoring or link recovery sent by the network device 101, where the pilot configuration information at least includes semi-persistent pilot information;

step S203, the user equipment 102 determines a pilot for radio link monitoring or link recovery based on the pilot configuration information.

In some possible examples, the pilot configuration information merely includes semi-persistent pilot information.

In some possible examples, in addition to the semi-persistent pilot information, the pilot configuration information further includes periodic pilot information. That is, the pilot configuration information includes both the semi-persistent pilot information and the periodic pilot information.

In some possible examples, the pilot for radio link monitoring or link recovery is a CSI-RS.

In some possible examples, the pilot for radio link monitoring or link recovery is determined preferentially based on the semi-persistent pilot information.

In an example, in response to the pilot configuration information merely including the semi-persistent pilot information, the pilot for radio link monitoring or link recovery is determined based on the semi-persistent pilot information.

In another example, in response to the pilot configuration information including both the semi-persistent pilot information and the periodic pilot information, the pilot for radio link monitoring or link recovery is determined based on the semi-persistent pilot information.

In some possible examples, the method further includes: the network device 101 sends activation information to the user equipment 102, where the activation information is configured to activate at least one semi-persistent pilot.

The pilot for radio link monitoring or link recovery is determined as: the at least one semi-persistent pilot activated by the activation information.

In an example, the at least one semi-persistent pilot activated by the activation information is all or part of a pilot corresponding to the semi-persistent pilot information in the pilot configuration information.

In an example, the activation information is carried in a PDCCH or PDSCH.

In some possible examples, the method further includes: the network device 101 sends deactivation information to the user equipment 102, where the deactivation information is configured to deactivate at least one semi-persistent pilot.

The pilot for radio link monitoring or link recovery is determined as: a pilot other than the at least one semi-persistent pilot deactivated by the deactivation information in semi-persistent pilot corresponding to the semi-persistent pilot information.

In an example, the at least one semi-persistent pilot deactivated by the deactivation information is all or part of a pilot corresponding to the semi-persistent pilot information in the pilot configuration information.

In an example, the deactivation information is carried in a PDCCH or PDSCH.

By sending the activation information and the deactivation information to the user equipment, the network device enables the user equipment to be activated different semi-persistent pilots in different time periods, so that a base station may adjust the pilot flexibly and dynamically, achieving an energy-saving effect.

In a specific example, the semi-persistent pilot information in the pilot configuration information corresponds to a pilot A, a pilot B, and a pilot C. The user equipment 102 receives activation information. The activation information activates semi-persistent pilots A and B. Subsequently, the user equipment 102 receives deactivation information and activation information successively within a time duration. The deactivation information deactivates the semi-persistent pilot B. The activation information activates a semi-persistent pilot C.

In another specific example, the semi-persistent pilot information in the pilot configuration information corresponds to a pilot A, a pilot B, and a pilot C. The user equipment 102 receives activation information. The activation information activates semi-persistent pilots A and B. Subsequently, the user equipment 102 receives activation information and deactivation information successively within a time duration. The activation information activates the semi-persistent pilot C. The deactivation information deactivates the semi-persistent pilot B.

An example of the disclosure provides a method for determining pilot. The method includes:
step S201′, a network device 101 sends pilot configuration information for radio link monitoring or link recovery to user equipment 102, where the pilot configuration information at least includes semi-persistent pilot information and periodic pilot information;
step S202′, the user equipment 102 receives the pilot configuration information for radio link monitoring or link recovery sent by the network device 101, where the pilot configuration information at least includes semi-persistent pilot information and periodic pilot information;
step S203′, the user equipment 102 determines a pilot for radio link monitoring or link recovery based on the pilot configuration information.

In some possible examples, the method further includes: the network device 101 sends activation information to the user equipment 102, where the activation information is configured to activate at least one semi-persistent pilot.

Determining the pilot for radio link monitoring or link recovery based on the pilot configuration information includes:
determining that the pilot for radio link monitoring or link recovery includes: a default pilot and at least one semi-persistent pilot activated by the activation information.

In some possible examples, the method further includes: the network device 101 sends activation information to the user equipment 102, where the activation information is configured to activate at least one semi-persistent pilot.

Determining the pilot for radio link monitoring or link recovery based on the pilot configuration information includes:
determining that the pilot for radio link monitoring or link recovery includes at least one semi-persistent pilot activated by the activation information but does not include a default pilot.

In some possible examples, the method further includes: the network device 101 sends activation information to the user equipment 102, where the activation information is configured to activate at least one semi-persistent pilot; and
determining the pilot for radio link monitoring or link recovery based on the pilot configuration information includes:
determining that the pilot for radio link monitoring or link recovery includes both a default pilot and at least one semi-persistent pilot activated by the activation information.

In some possible examples, in response to not receiving activation information for indicating all or part of pilot information in the semi-persistent pilot information, the pilot for radio link monitoring or link recovery is determined to be a default pilot.

In a possible example, the default pilot is a pilot corresponding to the periodic pilot information.

In a possible example, the default pilot is a periodic pilot defined by a protocol.

In an example of the disclosure, the network device configures, for the user equipment, the pilot configuration information including the semi-persistent pilot information, so that a pilot resource can be flexibly configured, saving energy consumption.

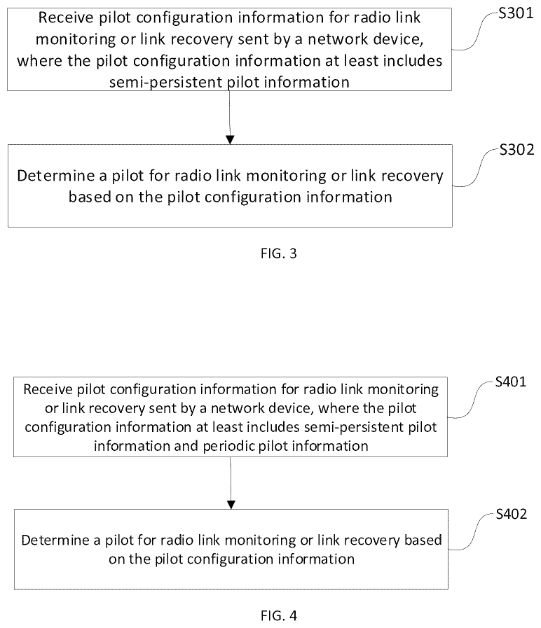

An example of the disclosure provides a method for determining pilot. This method is performed by user equipment 102. FIG. 3 is a flowchart of a method for determining pilot illustrated according to an illustrative example. As shown in FIG. 3, this method includes:
step S301, receiving pilot configuration information for radio link monitoring or link recovery sent by a network device, where the pilot configuration information at least includes semi-persistent pilot information; and
step S302, determining a pilot for radio link monitoring or link recovery based on the pilot configuration information.

In some possible examples, the pilot configuration information merely includes semi-persistent pilot information.

In some possible examples, the pilot for radio link monitoring or link recovery is a CSI-RS.

In some possible examples, the pilot for radio link monitoring or link recovery is determined based on the semi-persistent pilot information.

In an example, in response to the pilot configuration information merely including the semi-persistent pilot information, the pilot for radio link monitoring or link recovery is determined based on the semi-persistent pilot information.

In some possible examples, the method further includes: the network device 101 sends activation information to the user equipment 102, where the activation information is configured to activate at least one semi-persistent pilot.

The pilot for radio link monitoring or link recovery is determined as: at least one semi-persistent pilot activated by the activation information.

In an example, the at least one semi-persistent pilot activated by the activation information is all or part of a pilot corresponding to the semi-persistent pilot information in the pilot configuration information.

In an example, the activation information is carried in a PDCCH or PDSCH. For example, a PDCCH or PDSCH sent by the network device is received, where the PDCCH or PDSCH includes the activation information.

In some possible examples, the method further includes: the network device 101 sends deactivation information to the user equipment 102, where the deactivation information is configured to deactivate at least one semi-persistent pilot.

The pilot for radio link monitoring or link recovery is determined as: a pilot other than the at least one semi-persistent pilot deactivated by the deactivation information in semi-persistent pilot corresponding to the semi-persistent pilot information.

In an example, the at least one semi-persistent pilot deactivated by the deactivation information is all or part of a pilot corresponding to the semi-persistent pilot information in the pilot configuration information.

In an example, the deactivation information is carried in a PDCCH or PDSCH. For example, a PDCCH or PDSCH sent by the network device is received, where the PDCCH or PDSCH includes the deactivation information.

By sending the activation information and the deactivation information to the user equipment, the network device enables the user equipment to be activated different semi-persistent pilots in different time periods, so that a base station may adjust the pilot flexibly and dynamically, achieving an energy-saving effect.

In a specific example, the semi-persistent pilot information in the pilot configuration information corresponds to a pilot A, a pilot B, and a pilot C. The user equipment 102 receives activation information. The activation information activates semi-persistent pilots A and B. Subsequently, the user equipment 102 receives deactivation information and activation information successively within a time duration. The deactivation information deactivates the semi-persistent pilot B. The activation information activates a semi-persistent pilot C.

In another specific example, the semi-persistent pilot information in the pilot configuration information corresponds to a pilot A, a pilot B, and a pilot C. The user equipment 102 receives activation information. The activation information activates semi-persistent pilots A and B. Subsequently, the user equipment 102 receives activation information and deactivation information successively within a time duration. The activation information activates a semi-persistent pilot C. The deactivation information deactivates the semi-persistent pilot B.

In an example of the disclosure, the network device configures, for the user equipment, the pilot configuration information including the semi-persistent pilot information, so that a pilot resource can be flexibly configured, saving energy consumption.

An example of the disclosure provides a method for determining pilot. This method is performed by user equipment 102. FIG. 4 is a flowchart of a method for determining pilot illustrated according to an illustrative example. As shown in FIG. 4, this method includes:
step S401, receiving pilot configuration information for radio link monitoring or link recovery sent by a network device, where the pilot configuration information at least includes semi-persistent pilot information and periodic pilot information; and
step S402, determining a pilot for radio link monitoring or link recovery based on the pilot configuration information.

In some possible examples, in addition to the semi-persistent pilot information, the pilot configuration information further includes periodic pilot information. That is, the pilot configuration information includes both the semi-persistent pilot information and the periodic pilot information.

In some possible examples, the pilot for radio link monitoring or link recovery is a CSI-RS.

In some possible examples, the pilot for radio link monitoring or link recovery is determined preferentially based on the semi-persistent pilot information.

In an example, in response to the pilot configuration information including the semi-persistent pilot information and the periodic pilot information, the pilot for radio link monitoring or link recovery is determined based on the semi-persistent pilot information.

In some possible examples, the method further includes: the network device 101 sends activation information to the user equipment 102, where the activation information is configured to activate at least one semi-persistent pilot.

The pilot for radio link monitoring or link recovery is determined as: the at least one semi-persistent pilot activated by the activation information.

In an example, the at least one semi-persistent pilot activated by the activation information is all or part of a pilot corresponding to the semi-persistent pilot information in the pilot configuration information.

In an example, the activation information is carried in a PDCCH or PDSCH. For example, a PDCCH or PDSCH sent by the network device is received, where the PDCCH or PDSCH includes the activation information.

In some possible examples, the method further includes: the network device 101 sends deactivation information to the user equipment 102, where the deactivation information is configured to deactivate at least one semi-persistent pilot.

The pilot for radio link monitoring or link recovery is determined as: a pilot other than the at least one semi-persistent pilot deactivated by the deactivation information in semi-persistent pilot corresponding to the semi-persistent pilot information.

In an example, the at least one semi-persistent pilot deactivated by the deactivation information is all or part of a pilot corresponding to the semi-persistent pilot information in the pilot configuration information.

In an example, the deactivation information is carried in a PDCCH or PDSCH. For example, a PDCCH or PDSCH sent by the network device is received, where the PDCCH or PDSCH includes the deactivation information.

By sending the activation information and the deactivation information to the user equipment, the network device enables the user equipment to be activated different semi-persistent pilots in different time periods, so that a base station may adjust the pilot flexibly and dynamically, achieving an energy-saving effect.

In a specific example, the semi-persistent pilot information in the pilot configuration information corresponds to a pilot A, a pilot B, and a pilot C. The user equipment 102 receives activation information. The activation information activates semi-persistent pilots A and B. Subsequently, the user equipment 102 receives deactivation information and activation information successively within a time duration. The deactivation information deactivates the semi-persistent pilot B. The activation information activates a semi-persistent pilot C.

In another specific example, the semi-persistent pilot information in the pilot configuration information corresponds to a pilot A, a pilot B, and a pilot C. The user equipment 102 receives activation information. The activation information activates semi-persistent pilots A and B. Subsequently, the user equipment 102 receives activation information and deactivation information successively within a time duration. The activation information activates a semi-persistent pilot C. The deactivation information deactivates the semi-persistent pilot B.

An example of the disclosure provides a method for determining pilot. This method is performed by user equipment 102 and includes:
receiving pilot configuration information for radio link monitoring or link recovery sent by a network device, where the pilot configuration information at least includes semi-persistent pilot information and periodic pilot information; and determining a pilot for radio link monitoring or link recovery based on the pilot configuration information.

In some possible examples, the method further includes: the user equipment 102 receives activation information sent by a network device 101, where the activation information is configured to activate at least one semi-persistent pilot.

Determining the pilot for radio link monitoring or link recovery based on the pilot configuration information includes:
determining that the pilot for radio link monitoring or link recovery includes: a default pilot and at least one semi-persistent pilot activated by the activation information.

In some possible examples, in response to not receiving activation information for indicating all or part of pilot information in the semi-persistent pilot information, the pilot for radio link monitoring or link recovery is determined to be a default pilot.

In an example of the disclosure, the network device configures, for the user equipment, the pilot configuration information including the semi-persistent pilot information and the periodic pilot information, so that a pilot resource can be flexibly configured, saving energy consumption.

An example of the disclosure provides a method for determining pilot. This method is performed by user equipment 102 and includes:
receiving pilot configuration information for radio link monitoring or link recovery sent by a network device, where the pilot configuration information at least includes semi-persistent pilot information and periodic pilot information; and determining a pilot for radio link monitoring or link recovery based on the pilot configuration information.

In some possible examples, the method further includes: the user equipment 102 receives activation information sent by a network device 101, where the activation information is configured to activate at least one semi-persistent pilot.

Determining the pilot for radio link monitoring or link recovery based on the pilot configuration information includes:
determining that the pilot for radio link monitoring or link recovery includes: the at least one semi-persistent pilot activated by the activation information but does not include a default pilot.

In some possible examples, in response to not receiving activation information for indicating all or part of pilot information in the semi-persistent pilot information, the pilot for radio link monitoring or link recovery is determined to be a default pilot.

In an example of the disclosure, the network device configures, for the user equipment, the pilot configuration information including the semi-persistent pilot information and the periodic pilot information, so that a pilot resource can be flexibly configured, saving energy consumption.

An example of the disclosure provides a method for determining pilot. This method is performed by user equipment 102 and includes:
receiving pilot configuration information for radio link monitoring or link recovery sent by a network device, where the pilot configuration information at least includes periodic pilot information; and
determining a pilot for radio link monitoring or link recovery based on the pilot configuration information.

In some possible examples, the pilot configuration information merely includes the periodic pilot information, but does not include semi-persistent pilot information.

In some possible examples, the pilot for radio link monitoring or link recovery is a CSI-RS.

In some possible examples, determining the pilot for radio link monitoring or link recovery based on the pilot configuration information includes: determining that the pilot for radio link monitoring or link recovery is a pilot corresponding to the periodic pilot information.

In some possible examples, the pilot for radio link monitoring or link recovery is determined to be a pilot corresponding to the periodic pilot information, and a default pilot is determined as the pilot corresponding to the periodic pilot information.

An example of the disclosure provides a method for determining pilot. This method is performed by a network device 101. FIG. 5 is a flowchart of a method for determining pilot illustrated according to an illustrative example. As shown in FIG. 5, this method includes:

step S501, sending pilot configuration information for radio link monitoring or link recovery to user equipment, where the pilot configuration information at least includes semi-persistent pilot information; where the pilot configuration information is configured for the user equipment to determine a pilot for radio link monitoring or link recovery based on the pilot configuration information.

In some possible examples, the pilot configuration information merely includes semi-persistent pilot information.

In some possible examples, the pilot used for radio link monitoring or link recovery is a CSI-RS.

In some possible examples, the user equipment determines the pilot for radio link monitoring or link recovery based on the semi-persistent pilot information.

In an example, the pilot configuration information merely includes semi-persistent pilot information. The user equipment determines the pilot for radio link monitoring or link recovery based on the semi-persistent pilot information.

In some possible examples, the method further includes: the network device 101 sends activation information to user equipment 102, where the activation information is configured to activate at least one semi-persistent pilot. The pilot configuration information is configured for the user equipment 102 to determine the pilot for radio link monitoring or link recovery as: the at least one semi-persistent pilot activated by the activation information.

In an example, the at least one semi-persistent pilot activated by the activation information is all or part of a pilot corresponding to the semi-persistent pilot information in the pilot configuration information.

In an example, the network device sends a PDCCH or PDSCH to the user equipment, where the PDCCH or PDSCH includes the activation information.

In some possible examples, the method further includes: the network device 101 sends deactivation information to the user equipment 102, where the deactivation information is configured to deactivate at least one semi-persistent pilot. The pilot configuration information is configured for the user equipment 102 to determine the pilot for radio link monitoring or link recovery as: a pilot other than the at least one semi-persistent pilot deactivated by the deactivation information in semi-persistent pilot corresponding to the semi-persistent pilot information.

In an example, the at least one semi-persistent pilot deactivated by the deactivation information is all or part of a pilot corresponding to the semi-persistent pilot information in the pilot configuration information.

In some possible examples, the network device sends a PDCCH or PDSCH to the user equipment, where the PDCCH or PDSCH includes the deactivation information.

By sending the activation information and the deactivation information to the user equipment, the network device enables the user equipment to be activated different semi-persistent pilots in different time periods, so that a base station may adjust the pilot flexibly and dynamically, achieving an energy-saving effect.

In a specific example, the semi-persistent pilot information in the pilot configuration information corresponds to a pilot A, a pilot B, and a pilot C. The user equipment 102 receives the activation information. The activation information activates semi-persistent pilots A and B. Subsequently, the user equipment 102 receives deactivation information and activation information successively within a time duration. The deactivation information deactivates the semi-persistent pilot B. The activation information activates a semi-persistent pilot C.

In another specific example, the semi-persistent pilot information in the pilot configuration information corresponds to a pilot A, a pilot B, and a pilot C. The user equipment 102 receives the activation information. The activation information activates semi-persistent pilots A and B. Subsequently, the user equipment 102 receives activation information and deactivation information successively within a time duration. The activation information activates a semi-persistent pilot C. The deactivation information deactivates the semi-persistent pilot B.

In an example of the disclosure, the network device configures, for the user equipment, the pilot configuration information including the semi-persistent pilot information, so that a pilot resource can be flexibly configured, saving energy consumption.

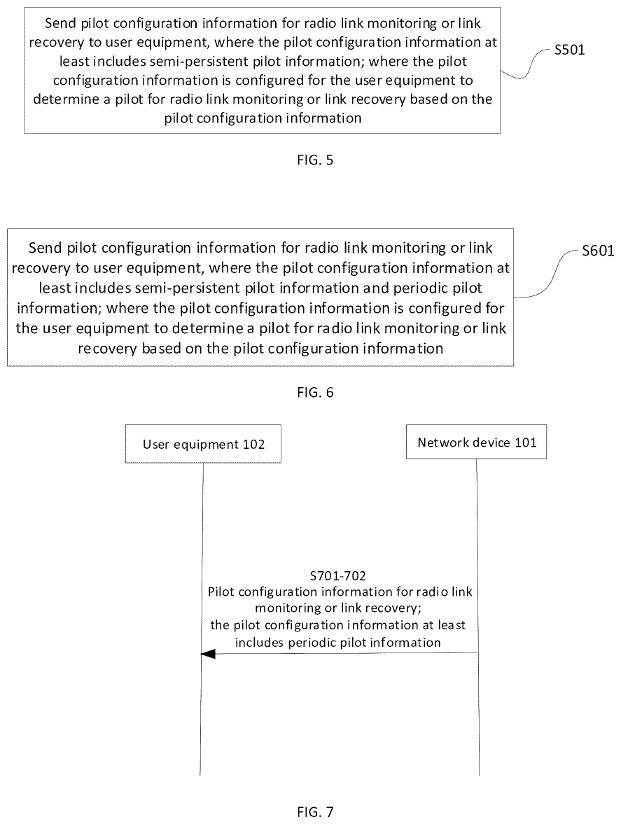

An example of the disclosure provides a method for determining pilot. This method is performed by a network device 101. FIG. 6 is a flowchart of a method for determining pilot illustrated according to an illustrative example. As shown in FIG. 6, this method includes:
step S601, sending pilot configuration information for radio link monitoring or link recovery to user equipment 102, where the pilot configuration information at least includes semi-persistent pilot information and periodic pilot information; where the pilot configuration information is configured for the user equipment 102 to determine a pilot for radio link monitoring or link recovery based on the pilot configuration information.

In some possible examples, in addition to the semi-persistent pilot information, the pilot configuration information further includes periodic pilot information. That is, the pilot configuration information includes both the semi-persistent pilot information and the periodic pilot information.

In some possible examples, the pilot for radio link monitoring or link recovery is a CSI-RS.

In some possible examples, the pilot for radio link monitoring or link recovery is determined preferentially based on the semi-persistent pilot information.

In an example, the pilot configuration information includes the semi-persistent pilot information and the periodic pilot information. The pilot configuration information is configured for the user equipment 102 to determine the pilot for radio link monitoring or link recovery based on the semi-persistent pilot information.

In some possible examples, the method further includes: the network device 101 sends activation information to the user equipment 102, where the activation information is configured to activate at least one semi-persistent pilot. The pilot configuration information is configured for the user equipment to determine the pilot for radio link monitoring or link recovery as: the at least one semi-persistent pilot activated by the activation information.

In an example, the at least one semi-persistent pilot activated by the activation information is all or part of a pilot corresponding to the semi-persistent pilot information in the pilot configuration information.

In one example, the activation information is carried in a PDCCH or PDSCH. The network device sends a PDCCH or PDSCH to the user equipment, where the PDCCH or PDSCH includes the activation information.

In some possible examples, the method further includes: the network device 101 sends deactivation information to the user equipment 102, where the deactivation information is configured to deactivate at least one semi-persistent pilot. The pilot configuration information is configured for the user equipment 102 to determine the pilot for radio link monitoring or link recovery as: a pilot other than the at least one semi-persistent pilot deactivated by the deactivation information in semi-persistent pilot corresponding to the semi-persistent pilot information.

In an example, the at least one semi-persistent pilot deactivated by the deactivation information is all or part of a pilot corresponding to the semi-persistent pilot information in the pilot configuration information.

In an example, the deactivation information is carried in a PDCCH or PDSCH. The network device sends a PDCCH or PDSCH to the user equipment, where the PDCCH or PDSCH includes the deactivation information.

By sending the activation information and the deactivation information to the user equipment, the network device enables the user equipment to be activated different semi-persistent pilots in different time periods, so that a base station may adjust the pilot flexibly and dynamically, achieving an energy-saving effect.

In a specific example, the semi-persistent pilot information in the pilot configuration information corresponds to a pilot A, a pilot B, and a pilot C. The user equipment 102 receives the activation information. The activation information activates semi-persistent pilots A and B. Subsequently, the user equipment 102 receives deactivation information and activation information successively within a time duration. The deactivation information deactivates the semi-persistent pilot B. The activation information activates a semi-persistent pilot C.

In another specific example, the semi-persistent pilot information in the pilot configuration information corresponds to a pilot A, a pilot B, and a pilot C. The user equipment 102 receives the activation information. The activation information activates semi-persistent pilots A and B. Subsequently, the user equipment 102 receives activation information and deactivation information successively within a time duration. The activation information activates a semi-persistent pilot C. The deactivation information deactivates the semi-persistent pilot B.

An example of the disclosure provides a method for determining pilot. This method is performed by a network device 101 and includes:
sending pilot configuration information for radio link monitoring or link recovery to user equipment 102, where the pilot configuration information at least includes semi-persistent pilot information and periodic pilot information; where the pilot configuration information is configured for the user equipment 102 to determine a pilot for radio link monitoring or link recovery based on the pilot configuration information.

In some possible examples, the method further includes: the network device 101 sending activation information to the user equipment 102, where the activation information is configured to activate at least one semi-persistent pilot.

Determining the pilot for radio link monitoring or link recovery based on the pilot configuration information includes:
determining that the pilot for radio link monitoring or link recovery includes: a default pilot and at least one semi-persistent pilot activated by the activation information.

In some possible examples, the method further includes: the network device 101 sends activation information to the user equipment 102, where the activation information is configured to activate at least one semi-persistent pilot. The pilot configuration information is configured for the user equipment to determine that the pilot for radio link monitoring or link recovery includes the at least one semi-persistent pilot activated by the activation information but does not include a default pilot.

In some possible examples, the method further includes: the network device 101 sends activation information to the user equipment 102, where the activation information is configured to activate the at least one semi-persistent pilot; and
the pilot configuration information is configured for the user equipment to determine that the pilot for radio link monitoring or link recovery includes both the at least one semi-persistent pilot activated by the activation information and a default pilot.

In an example, the default pilot is a pilot corresponding to the periodic pilot information.

In an example, the default pilot is a periodic pilot defined by a protocol.

In an example of the disclosure, the network device configures, for the user equipment, the pilot configuration information including the semi-persistent pilot information and the periodic pilot information, so that a pilot resource can be flexibly configured, saving energy consumption.

An example of the disclosure provides a method for determining pilot. This method is performed by a network device 101 and includes:
sending pilot configuration information for radio link monitoring or link recovery to user equipment, where the pilot configuration information at least includes periodic pilot information.

The pilot configuration information is configured for the user equipment to determine a pilot for radio link monitoring or link recovery based on the pilot configuration information.

In some possible examples, the pilot configuration information merely includes the periodic pilot information, but does not include semi-persistent pilot information.

In some possible examples, the pilot for radio link monitoring or link recovery is a CSI-RS.

In some possible examples, the pilot configuration information is configured for the user equipment to determine the pilot for radio link monitoring or link recovery as a pilot corresponding to the periodic pilot information.

In some possible examples, the pilot configuration information is configured for the user equipment to determine the pilot for radio link monitoring or link recovery is the pilot corresponding to the periodic pilot information, and determine a default pilot as the pilot corresponding to the periodic pilot information.

An example of the disclosure provides a method for determining pilot. FIG. 7 is a flowchart of a method for determining pilot illustrated according to an illustrative example. As shown in FIG. 7, the method includes:
step S701, a network device 101 sends pilot configuration information for radio link monitoring or link recovery to user equipment 102, where the pilot configuration information includes periodic pilot information. The periodic pilot information includes a first parameter set; and a first parameter in the first parameter set includes one or more of a period, an RB number, a frequency domain density, and a power parameter; and
step S702, the user equipment 102 receives the pilot configuration information for radio link monitoring or link recovery sent by the network device 101.

In a possible example, the method further includes: step S703. the user equipment 102 determines a pilot for radio link monitoring or link recovery based on the periodic pilot information.

In a possible example, the method further includes: the user equipment receives activation information sent by the network device, where the activation information is configured to activate a set of parameter values of one or more first parameters in the first parameter set.

In a possible example, signaling corresponding to the activation information is MAC CE or DCI.

In a possible example, one or more first parameters in the first parameter set correspond to default parameter values, and the default parameter values are stipulated based on a protocol or configured by the network device.

In an example of the disclosure, the network device configures, for the user equipment, the pilot configuration information including the periodic pilot information, and parameter values of the periodic pilot information are adjusted flexibly, so that a pilot resource can be flexibly configured, saving energy consumption.

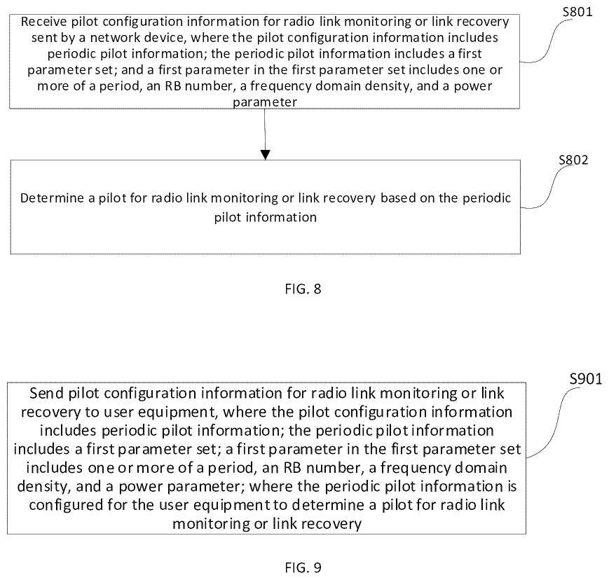

An example of the disclosure provides a method for determining pilot. This method is performed by user equipment 102. FIG. 8 is a flowchart of a method for determining pilot illustrated according to an illustrative example. As shown in FIG. 8, this method includes:
step S801, receiving pilot configuration information for radio link monitoring or link recovery sent by a network device, where the pilot configuration information includes periodic pilot information; the periodic pilot information includes a first parameter set; a first parameter in the first parameter set includes one or more of a period, an RB number, a frequency domain density, and a power parameter; where the periodic pilot information is configured for the user equipment to determine a pilot for radio link monitoring or link recovery; and
step S802, determining the pilot for radio link monitoring or link recovery based on the periodic pilot information.

In a possible example, the method further includes: the user equipment 102 determines a pilot for radio link monitoring or link recovery based on the periodic pilot information.

In a possible example, the method further includes: activation information sent by the network device is received, where the activation information is configured to activate a set of parameter values of one or more first parameters in the first parameter set. In an example, signaling corresponding to the activation information is MAC CE or DCI.

In a possible example, one or more first parameters in the first parameter set correspond to default parameter values. The default parameter values are stipulated based on a protocol or configured by the network device.

In an example of the disclosure, the network device configures, for the user equipment, the pilot configuration information including the periodic pilot information, and parameter values of the periodic pilot information are adjusted flexibly, so that a pilot resource can be flexibly configured, saving energy consumption.

An example of the disclosure provides a method for determining pilot. This method is performed by a network device 101. FIG. 9 is a flowchart of a method for determining pilot illustrated according to an illustrative example. As shown in FIG. 9, this method includes:
step S901, sending pilot configuration information for radio link monitoring or link recovery to user equipment, where the pilot configuration information includes periodic pilot information; the periodic pilot information includes a first parameter set; a first parameter in the first parameter set includes one or more of a period, an RB number, a frequency domain density, and a power parameter; where the periodic pilot information is configured for the user equipment to determine a pilot for radio link monitoring or link recovery.

In a possible example, the method further includes: activation information is sent to the user equipment, where the activation information is configured to activate a set of parameter values of one or more first parameters in the first parameter set. In an example, signaling corresponding to the activation information is MAC CE or DCI.

In a possible example, one or more first parameters in the first parameter set correspond to default parameter values. The default parameter values are stipulated based on a protocol or configured by the network device.

In an example of the disclosure, the network device configures, for the user equipment, the pilot configuration information including the periodic pilot information, and parameter values of the periodic pilot information are adjusted flexibly, so that a pilot resource can be flexibly configured, saving energy consumption.

Based on the same concept as the above method examples, an example of the disclosure further provides a communication apparatus. The communication apparatus may possess a function of the user equipment 102 in the method examples and be configured to perform the steps performed by the user equipment 102 provided in the above examples. This function may be implemented by hardware, or implemented by performing corresponding software with software or hardware. This hardware or software includes one or more modules corresponding to the above functions.

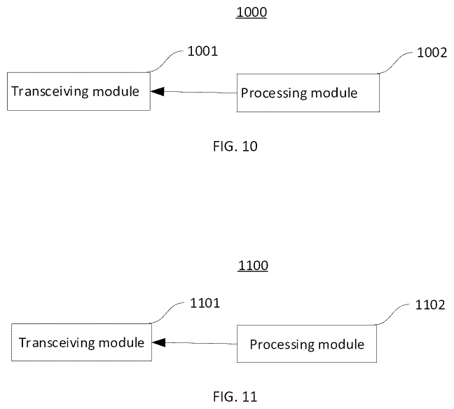

In a possible implementation, a communication apparatus 1000 as shown in FIG. 10 may be user equipment 102 involved in the above method examples, and perform the steps performed by the user equipment 102 in the above method examples.

The communication apparatus 1000 includes: a transceiving module 1001, configured to receive pilot configuration information for radio link monitoring or link recovery sent by a network device, where the pilot configuration information at least includes semi-persistent pilot information; and
a processing module 1002, configured to determine a pilot for radio link monitoring or link recovery based on the pilot configuration information.

In some possible examples, the pilot configuration information further includes periodic pilot information.

In some possible examples, the processing module 1002 is also configured to determine the pilot for radio link monitoring or link recovery based on the semi-persistent pilot information.

In some possible examples, the transceiving module 1001 is also configured to receive activation information sent by the network device, where the activation information is configured to activate at least one semi-persistent pilot.

The processing module 1002 is also configured to determine the pilot for radio link monitoring or link recovery as: the at least one semi-persistent pilot activated by the activation information.

In some possible examples, the transceiving module 1001 is also configured to receive deactivation information sent by the network device, where the deactivation information is configured to deactivate at least one semi-persistent pilot.

The processing module 1002 is also configured to determine the pilot for radio link monitoring or link recovery as: a pilot other than the at least one semi-persistent pilot deactivated by the deactivation information in semi-persistent pilot corresponding to the semi-persistent pilot information.

In some possible examples, the transceiving module 1001 is also configured to receive a PDCCH or PDSCH sent by the network device, where the PDCCH or PDSCH includes at least one of activation information and deactivation information.

In some possible examples, the transceiving module 1001 is also configured to receive activation information sent by the network device, where the activation information is configured to activate at least one semi-persistent pilot.

The processing module 1002 is also configured to determine that the pilot for radio link monitoring or link recovery includes: a default pilot and the at least one semi-persistent pilot activated by the activation information.

In some possible examples, the processing module 1002 is configured to, in response to not receiving activation information for indicating all or part of pilot information in the semi-persistent pilot information, determine the pilot for radio link monitoring or link recovery is a default pilot.

In some possible examples, the pilot configuration information further includes periodic pilot information; and
the default pilot is a pilot corresponding to the periodic pilot information.

In some possible examples, the default pilot is a periodic pilot defined by a protocol.

In a possible implementation, a communication apparatus 1100 as shown in FIG. 11 may be user equipment 102 involved in the above method examples, and perform the steps performed by the user equipment 102 in the above method examples.

The communication apparatus 1100 includes: a transceiving module 1101, configured to receive pilot configuration information for radio link monitoring or link recovery sent by a network device, where the pilot configuration information includes periodic pilot information; the periodic pilot information includes a first parameter set; and a first parameter in the first parameter set includes one or more of a period, an RB number, a frequency domain density, and a power parameter.

In some possible examples, the transceiving module 1101 is also configured to receive activation information sent by the network device, where the activation information is configured to activate a set of parameter values of one or more first parameters in the first parameter set.

A processing module 1102 is configured to determine a pilot for radio link monitoring or link recovery based on the periodic pilot information.

In some possible examples, signaling corresponding to the activation information is MAC CE or DCI.

In some possible examples, one or more first parameters in the first parameter set correspond to default parameter values. The default parameter values are stipulated based on a protocol or configured by the network device.

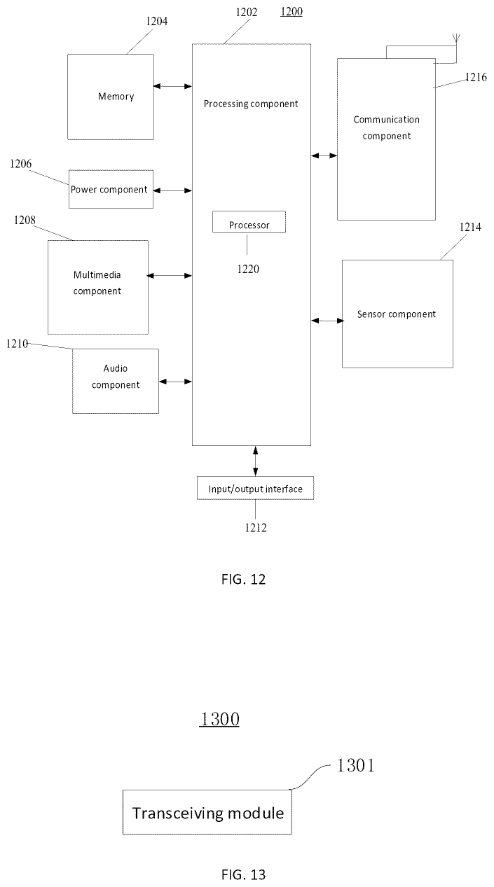

In the case that the communication apparatus is user equipment 102, the structure of this communication apparatus may also be shown in FIG. 12. Referring to FIG. 12, the apparatus 1200 may include one or more of the following components: a processing component 1202, a memory 1204, a power component 1206, a multimedia component 1208, an audio component 1210, an input/output (I/O) interface 1212, a sensor component 1214, and a communication component 1216.

The processing component 1202 typically controls overall operations of the control apparatus 1200, such as the operations associated with display, telephone calls, data communications, camera operations, and recording operations. The processing component 1202 may include one or more processors 1220 to execute instructions to complete all or part of the steps of the method described above. In addition, the processing component 1202 may include one or more modules to facilitate interaction between the processing component 1202 and other components. For instance, the processing component 1202 may include a multimedia module to facilitate the interaction between the multimedia component 1208 and the processing component 1202.

The memory 1204 is configured to support operations on the apparatus 1200 by storing various types of data. Examples of such data include instructions for any application programs or methods operated on the apparatus 1200, contact data, phonebook data, messages, pictures, video, etc. The memory 1204 may be implemented by any type of volatile or non-volatile memory devices, or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1206 provides power to various components of the apparatus 1200. The power component 1206 may include a power management system, one or more power sources, and any other components associated with the generation, management, and distribution of power for the apparatus 1200.

The multimedia component 1208 includes a screen providing an output interface between the apparatus 1200 and a user. In some examples, the screen may include a liquid crystal display (LCD) and a touch panel (TP). If the screen includes the touch panel, the screen may be implemented as a touch screen to receive input signals from the user. The touch panel includes one or more touch sensors to sense touch, swipe, and gestures on the touch panel. The touch sensors may not only sense a boundary of a touch or swipe action, but also detect a duration and a pressure associated with the touch or swipe action. In some examples, the multimedia component 1208 includes a front camera and/or a rear camera. The front camera and/or the rear camera may receive external multimedia data while the apparatus 1200 is in an operation mode, such as a shooting mode or a video mode. Each of the front camera and the rear camera may be a fixed optical lens system or have focal length and optical zoom capability.

The audio component 1210 is configured to output and/or input audio signals. For example, the audio component 1210 includes a microphone (MIC) configured to receive an external audio signal when the apparatus 1200 is in an operation mode, such as a call mode, a recording mode, and a voice recognition mode. The received audio signal may be further stored in the memory 1204 or transmitted via the communication component 1216. In some examples, the audio component 1210 further includes a speaker to output the audio signal.

The I/O interface 1212 provides an interface between the processing component 1202 and peripheral interface modules, such as a keyboard, a click wheel and buttons. The buttons may include but be not limited to a home button, a volume button, a starting button, and a locking button.

The sensor component 1214 includes one or more sensors that are configured to provide status assessments in various aspects for the apparatus 1200. For instance, the sensor component 1214 may detect an open/closed status of the apparatus 1200, relative positioning of components, e.g., the display and the keypad of the apparatus 1200. The sensor component 1214 may also detect a change in position of the apparatus 1200 or a component of the apparatus 1200, a presence or absence of user contact with the apparatus 1200, an orientation or an acceleration/deceleration of the apparatus 1200, and a change in temperature of the apparatus 1200. The sensor component 1214 may include a proximity sensor configured to detect the presence of nearby objects without any physical contact. The sensor component 1214 may further include a light sensor, such as a CMOS or CCD image sensor, for use in imaging applications. In some examples, the sensor component 1214 may further include an accelerometer sensor, a gyroscope sensor, a magnetic sensor, a pressure sensor, or a temperature sensor.

The communication component 1216 is configured to facilitate wired or wireless communication between the apparatus 1200 and other devices. The apparatus 1200 may access a wireless network based on a communication standard, such as WiFi, 4G, or 5G, or a combination of them. In an illustrative example, the communication component 1216 receives a broadcast signal or broadcast associated information from an external broadcast management system via a broadcast channel. In an illustrative example, the communication component 1216 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an illustrative example, the apparatus 1200 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above methods.

In an illustrative example, a non-transitory computer-readable storage medium including instructions is also provided, such as the memory 1204 including instructions, which may be executed by the processor 1220 of the apparatus 1200 to accomplish the above methods. For example, the non-transitory computer-readable storage medium may be an ROM, a random access memory (RAM), a CD-ROM, a magnetic tape, a floppy disk, an optical data storage device, etc.

Based on the same concept as the above method examples, an example of the disclosure further provides a communication apparatus. The communication apparatus may possess a function of the network device 101 in the above method examples and be configured to perform the steps performed by the network device 101 provided in the above examples. This function may be implemented by hardware, or implemented by performing corresponding software with software or hardware. This hardware or software includes one or more modules corresponding to the above functions.

In a possible implementation, a communication apparatus 1300 as shown in FIG. 13 may be a network device 101 involved in the above method examples, and perform the steps performed by the network device 101 in the above method examples.

The communication apparatus 1300 includes: a transceiving module 1301, configured to send pilot configuration information for radio link monitoring or link recovery to user equipment, where the pilot configuration information at least includes semi-persistent pilot information.

In a possible implementation, the pilot configuration information further includes periodic pilot information.

In a possible implementation, the pilot configuration information is configured to indicate the user equipment to determine the pilot for radio link monitoring or link recovery based on the semi-persistent pilot information.

In a possible implementation, the transceiving module 1301 is also configured to send activation information to the user equipment, where the activation information is configured to activate at least one semi-persistent pilot; and
the pilot configuration information is configured to indicate the user equipment to determine the pilot for radio link monitoring or link recovery as: the at least one semi-persistent pilot activated by the activation information.

In a possible implementation, the transceiving module 1301 is also configured to send deactivation information to the user equipment, where the deactivation information is configured to deactivate at least one semi-persistent pilot; and
the pilot configuration information is configured to indicate the user equipment to determine the pilot for radio link monitoring or link recovery as: a pilot other than the at least one semi-persistent pilot deactivated by the deactivation information in semi-persistent pilot corresponding to the semi-persistent pilot information.

In a possible implementation, the transceiving module 1301 is also configured to send a PDCCH or PDSCH to the user equipment, where the PDCCH or PDSCH includes at least one of activation information and deactivation information.

In a possible implementation, the transceiving module 1301 is also configured to send activation information to the user equipment, where the activation information is configured to activate at least one semi-persistent pilot; and
the pilot configuration information is configured to indicate the user equipment to determine that the pilot for radio link monitoring or link recovery includes: a default pilot and the at least one semi-persistent pilot activated by the activation information.

In a possible implementation, the pilot configuration information further includes periodic pilot information; and
the default pilot is a pilot corresponding to the periodic pilot information.

In a possible implementation, the default pilot is a periodic pilot defined by a protocol.

Based on the same concept as the above method examples, an example of the disclosure further provides a communication apparatus. The communication apparatus may possess a function of the network device 101 in the above method examples and be configured to perform the steps performed by the network device 101 provided in the above examples. This function may be implemented by hardware, or implemented by performing corresponding software with software or hardware. This hardware or software includes one or more modules corresponding to the above functions.

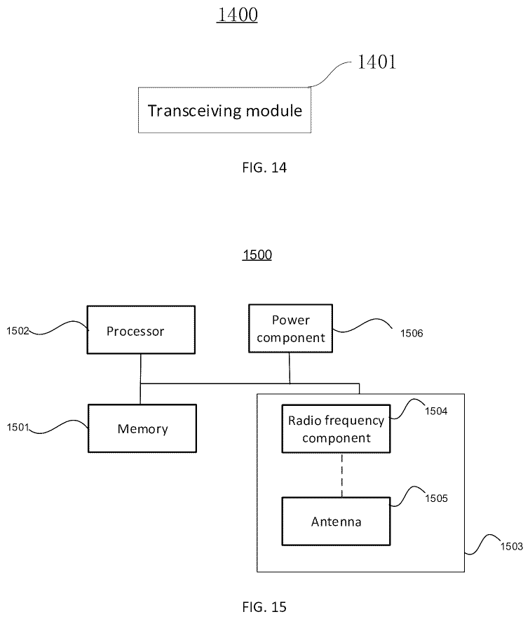

In a possible implementation, a communication apparatus 1400 as shown in FIG. 14 may be a network device 101 involved in the above method examples, and perform the steps performed by the network device 101 in the above method examples.

The communication apparatus 1400 includes: a transceiving module 1401, configured to send pilot configuration information for radio link monitoring or link recovery to user equipment, where the pilot configuration information includes periodic pilot information; the periodic pilot information includes a first parameter set; and a first parameter in the first parameter set includes one or more of a period, an RB number, a frequency domain density, and a power parameter.

In a possible implementation, the transceiving module 1401 is also configured to send activation information to the user equipment, where the activation information is configured to activate a set of parameter values of one or more first parameters in the first parameter set.

In a possible implementation, signaling corresponding to the activation information is MAC CE or DCI.

In a possible implementation, one or more first parameters in the first parameter set of the periodic pilot information correspond to default parameter values. The default parameter values are stipulated based on a protocol or configured by the network device.

In the case that the communication apparatus is a network device, the structure of this communication apparatus may also be shown in FIG. 15. The structure of the communication apparatus is illustrated by taking the network device 101 being a base station as an example. As shown in FIG. 15, the apparatus 1500 includes a memory 1501, a processor 1502, a transceiving component 1503, and a power component 1506. Where, the memory 1501 is coupled with the processor 1502 and may be configured to store programs and data essential for the communication apparatus 1500 to implement various functions. The processor 1502 is configured to support the communication apparatus 1500 to perform the corresponding function in the above methods. This function may be achieved by calling a program stored in the memory 1501. The transceiving component 1503 may be a wireless transceiver that may be configured to support the communication apparatus 1500 to receive signaling and/or data through a wireless air interface and to send the signaling and/or data. The transceiving component 1503 may also be called a transceiving unit or a communication unit. The transceiving component 1503 may include a radio frequency component 1504 and one or more antennas 1505, where the radio frequency component 1504 may be a remote radio unit (RRU), which may be specifically configured for the transmission of a radio frequency signal and the conversion between the radio frequency signal and a baseband signal. The one or more antennas 1505 may be specifically configured to carry out radiation and reception of radio frequency signals.

In the case that the communication apparatus 1500 needs to send data, the processor 1502 may carry out baseband processing on data to be sent, and output a baseband signal to the radio frequency unit; and the radio frequency unit may carry out radio frequency processing on the baseband signal, and send the radio frequency signal in the form of electromagnetic waves through the antenna. In the case that data is sent to the communication apparatus 1500, the radio frequency unit receives a radio frequency signal through the antenna, converts the radio frequency signal into a baseband signal, and outputs the baseband signal to the processor 1502; and the processor 1502 converts the baseband signal into data and processes this data.

Those skilled in the art will readily conceive other implementations of the examples of the disclosure upon consideration of the specification and practice of the disclosure disclosed here. The disclosure is intended to cover any variations, uses, or adaptations of the examples of the disclosure. These variations, uses, or adaptations follow the general principles of the examples of the disclosure and include common knowledge or customary technical means in the art which are not disclosed herein. The specification and examples are to be considered as illustrative.

It will be appreciated that the examples of the disclosure are not limited to the exact construction that has been described above and illustrated in the accompanying drawings, and that various modifications and changes can be made without departing from the scope of the disclosure. The scope of the examples of the disclosure is limited by the appended claims.

### INDUSTRIAL APPLICABILITY

The network device configures, for the user equipment, the pilot configuration information including the semi-persistent pilot information, so that a pilot resource can be flexibly configured, saving energy consumption.

1. A method for determining pilot, performed by user equipment, and comprising:
receiving pilot configuration information for radio link monitoring or link recovery sent by a network device, wherein the pilot configuration information at least comprises semi-persistent pilot information; and
determining a pilot for radio link monitoring or link recovery based on the pilot configuration information.

2. The method according to claim 1, wherein:
the pilot configuration information further comprises periodic pilot information.

3. (canceled)

4. The method according to claim 1, wherein:
determining the pilot for radio link monitoring or link recovery based on the semi-persistent pilot information comprises:
receiving activation information sent by the network device, wherein the activation information is configured to activate at least one semi-persistent pilot; and
determining the pilot for radio link monitoring or link recovery as the at least one semi-persistent pilot activated by the activation information.

5. The method according to claim 1, wherein:
determining the pilot for radio link monitoring or link recovery based on the semi-persistent pilot information comprises:
receiving deactivation information sent by the network device, wherein the deactivation information is configured to deactivate at least one semi-persistent pilot; and
determining the pilot for radio link monitoring or link recovery as a pilot other than the at least one semi-persistent pilot deactivated by the deactivation information in semi-persistent pilot corresponding to the semi-persistent pilot information.

6. (canceled)

7. The method according to claim 1, wherein:
the method further comprises:
receiving activation information sent by the network device, wherein the activation information is configured to activate at least one semi-persistent pilot; and
determining the pilot for radio link monitoring or link recovery based on the pilot configuration information comprises:
determining that the pilot for radio link monitoring or link recovery comprises a default pilot and the at least one semi-persistent pilot activated by the activation information.

8. The method according to claim 1, wherein:
determining the pilot for radio link monitoring or link recovery based on the pilot configuration information comprises:
in response to not receiving activation information for indicating all or part of pilot information in the semi-persistent pilot information, determining the pilot for radio link monitoring or link recovery is a default pilot.

9. The method according to claim 1, wherein:
the method further comprises:
receiving activation information sent by the network device, wherein the activation information is configured to activate at least one semi-persistent pilot; and
determining the pilot for radio link monitoring or link recovery based on the pilot configuration information comprises:
determining that the pilot for radio link monitoring or link recovery comprises the at least one semi-persistent pilot activated by the activation information but does not comprise a default pilot.

10. The method according to claim 7, wherein:
the pilot configuration information further comprises periodic pilot information; and
the default pilot is a pilot corresponding to the periodic pilot information, or a periodic pilot defined by a protocol.

11. (canceled)

12. A method for determining pilot, performed by a network device, and comprising:
sending pilot configuration information for radio link monitoring or link recovery to user equipment, wherein the pilot configuration information at least comprises semi-persistent pilot information; wherein the pilot configuration information is configured for the user equipment to determine a pilot for radio link monitoring or link recovery.

13. The method according to claim 12, wherein:
the pilot configuration information further comprises periodic pilot information.

14. (canceled)

15. The method according to claim 12, wherein:
the method further comprises:
sending activation information to the user equipment, wherein the activation information is configured to activate at least one semi-persistent pilot; and
the pilot configuration information is configured to indicate the pilot for radio link monitoring or link recovery as the at least one semi-persistent pilot activated by the activation information.

16. The method according to claim 12, wherein:
the method further comprises:
sending deactivation information to the user equipment, wherein the deactivation information is configured to deactivate at least one semi-persistent pilot; and
the pilot configuration information is configured to indicate the pilot for radio link monitoring or link recovery as a pilot other than the at least one semi-persistent pilot deactivated by the deactivation information in semi-persistent pilot corresponding to the semi-persistent pilot information.

17. (canceled)

18. The method according to claim 12, wherein:
the method further comprises:
sending activation information to the user equipment, wherein the activation information is configured to activate at least one semi-persistent pilot; and
the pilot configuration information is configured to indicate that the pilot for radio link monitoring or link recovery comprises a default pilot and the at least one semi-persistent pilot activated by the activation information.

19. The method according to claim 12, wherein:
the method further comprises:
sending activation information to the user equipment, wherein the activation information is configured to activate at least one semi-persistent pilot; and
the pilot configuration information is configured to indicate that the pilot for radio link monitoring or link recovery comprises the at least one semi-persistent pilot activated by the activation information but does not comprise a default pilot.

20. (canceled)

21. (canceled)

22. A method for determining pilot, performed by user equipment, and comprising:
receiving pilot configuration information for radio link monitoring or link recovery sent by a network device, wherein the pilot configuration information comprises periodic pilot information; the periodic pilot information comprises a first parameter set; and a first parameter in the first parameter set comprises one or more of a period, an RB number, a frequency domain density, and a power parameter; and
determining a pilot for radio link monitoring or link recovery based on the periodic pilot information.

23. The method according to claim 22, wherein:
the method further comprises:
receiving activation information sent by the network device, wherein the activation information is configured to activate a set of parameter values of one or more first parameters in the first parameter set.

24. (canceled)

25. (canceled)

26. A method for determining pilot, performed by a network device, and comprising:
sending pilot configuration information for radio link monitoring or link recovery to user equipment, wherein the pilot configuration information comprises periodic pilot information; the periodic pilot information comprises a first parameter set; a first parameter in the first parameter set comprises one or more of a period, an RB number, a frequency domain density, and a power parameter; wherein the periodic pilot information is configured for the user equipment to determine a pilot for radio link monitoring or link recovery.

27. The method according to claim 26, wherein:
the method further comprises:
sending activation information to the user equipment, wherein the activation information is configured to activate a set of parameter values of one or more first parameters in the first parameter set.

28-33. (canceled)

34. A communication apparatus, comprising a processor and a memory, wherein:
the memory is configured to store a computer program; and
the processor is configured to execute the computer program to implement the method according to claim 1.

35. A communication apparatus, comprising a processor and a memory, wherein:
the memory is configured to store a computer program; and
the processor is configured to execute the computer program to implement the method according claim 12.

36. (canceled)

37. (canceled)
